(19) United States
(12) Patent Application Publication
(10) Pub. No.: US 2004/0259054 A1
(43) Pub. Date: Dec. 23, 2004

(54) Grip for ultrasonic scaler

(76) Inventor: Stanley Mayer, Middletown, NY (US)

Correspondence Address: KATTEN MUCHIN ZAVIS ROSENMAN, 575 MADISON AVENUE, NEW YORK, NY, 10022-2585, US

(21) Appl. No.: 10/484,416

(22) PCT Filed: Jul. 24, 2002
(86) PCT No.: PCT/US02/23495

Related U.S. Application Data
(60) Provisional application No. 60/309,283, filed on Aug. 1, 2001.

(51) Int. Cl. A61C 3/03

(52) U.S. Cl. 433/119

(57) ABSTRACT

A grip for an ultrasonic scaler insert includes a soft grip portion externally attached to a rigid body having front, rear and central portions. The soft grip is attached to the rigid body either by adhesive or ovennolding, and includes a plurality of elongated ridges along an exterior surface of the soft grip. The elongated ridges are spaced apart on the exterior surface in a manner directed to follow finger placement on the grip, so that the grip may be easily manipulated. The material making up the soft grip helps to reduce vibrations transmitted to the user during operation of the ultrasonic scaler.

### CROSS-REFERENCE TO RELATED APPLICATION

The present application claims priority under 35 U.S.C. § 119(e) from U.S. Ser. No. 60/309,283, filed on Aug. 1, 2001. U.S. Ser. No. 60/309,283 was filed by at an inventor common to the present application, and is hereby incorporated by reference.

### FIELD OF THE INVENTION

This invention relates to a grip for an ultrasonic instrument, and more particularly, to a grip for an ultrasonic scaler insert having a soft exterior portion for isolating vibration.

### BACKGROUND OF THE INVENTION

Ultrasonic dental cleaning and scaling instruments are well known in the art for cleaning teeth. High frequency signals, usually in the range of 25 to 30 kHz, transmitted to the tip create high frequency vibrations in the instrument. These vibrations drastically improve the cleaning effectiveness of the scaler tip as is well known in the art.

Even though ultrasonic scaling instruments vibrate at very high frequencies, some of the vibration generated by the instrument tends to transmit to the fingers of the user. This transmission can be both uncomfortable and distracting, causing the user to be more concerned about gripping the instrument than cleaning the patient's teeth. Also, hard plastic surfaces characteristic of many scaling instruments are often slick when wet, which leads to excessive gripping force being required, fatiguing the user. Thus, there exists a need for grip for an ultrasonic scaler that is comfortable, easy to handle and grip, and reduces the transmission of vibrations to the hands of the user.

### SUMMARY OF THE INVENTION

The above-mentioned problems are solved by a novel grip for an ultrasonic scaler comprising a rigid body having a soft exterior grip portion. The rigid comprises front, rear and central portions, and a first cavity positioned along a central axis of the rigid body for fixedly receiving a tool shank. The soft grip portion is fixedly and coaxially attached to the central portion of the rigid body, the grip portion being confinedly positioned on the central portion between ledges defined by the front and rear portions. The soft grip portion further comprises one or more elongated ridges along an outer surface of the soft grip portion for more secure gripping of the soft grip portion by a user.

First and second embodiments of the present invention are disclosed in which an axial length of the rear portion of the rigid body varies in accordance with transducer length. In both embodiments, the rear portion further comprises a narrowed cylindrical segment having an annular groove for retaining an O-ring. The cylindrical segment and O-ring may be used, for example, to insert the manual grip into an ultrasonic scaler handle.

A shank incorporating a scaler tip to be vibrated may be sealably attached in the first cavity of the rigid body with adhesive. The soft grip portion may be fixedly attached to the rigid body by means of adhesive placed between an inner attachment surface of the soft grip portion and an outer surface of the central portion, or alternatively, by overmolding the soft grip portion onto the rigid body.

### BRIEF DESCRIPTION OF THE DRAWINGS

A more complete understanding of the invention may be obtained by reading the following description of specific illustrative embodiments of the invention in conjunction with the appended drawing in which:

FIG. 1 is a perspective view of an overmolded handle of the present invention.

FIG. 2 is a side elevation view thereof

FIG. 3 is a rear edge view thereof.

FIG. 4 is a front edge view thereof.

FIG. 5 is a perspective view thereof shown connected to the handle of an ultrasonic scaler.

FIG. 6 is a perspective view of a second embodiment of an overmolded handle of the present invention.

FIG. 7 is a side elevation view thereof.

FIG. 8 is a rear edge view thereof.

FIG. 9 is a front edge view thereof.

FIG. 10 is a perspective view thereof shown connected to the handle of an ultrasonic scaler.

FIG. 11 is a cross-sectional view of the grip portion of FIGS. 1-5.

FIG. 12 is a side elevation view of the grip portion of FIGS. 1-5 as part of a scaler insert.

FIG. 13 is a cross-sectional view of the grip portion of FIGS. 6-10.

FIG. 14 is a side elevation view of the grip portion of FIGS. 6-10 as part of a scaler insert.

### DETAILED DESCRIPTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

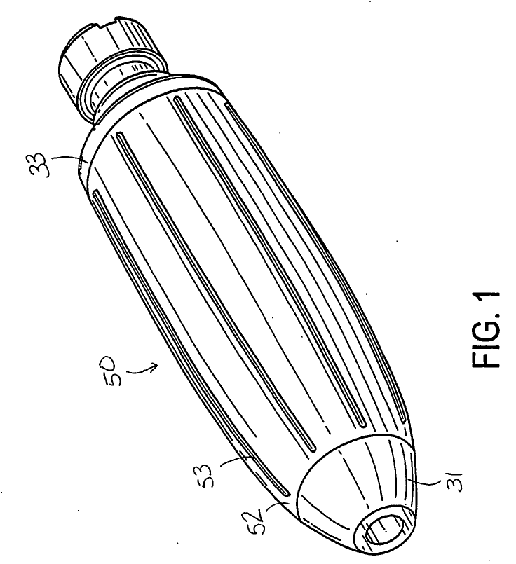

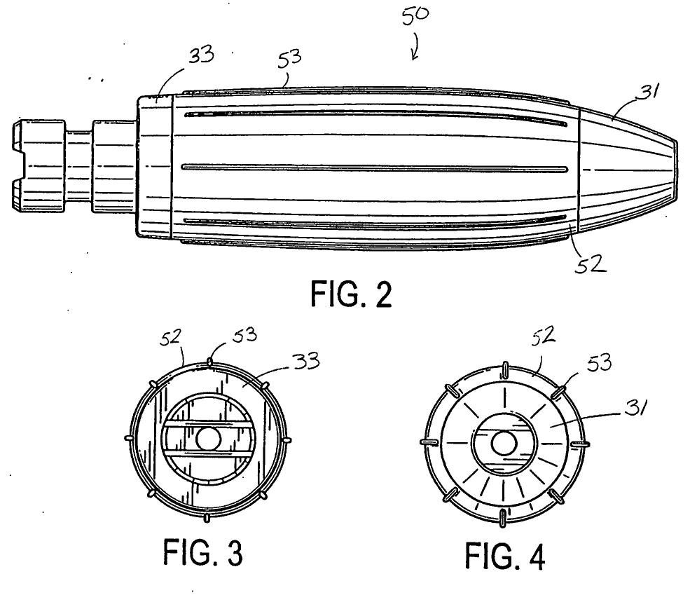

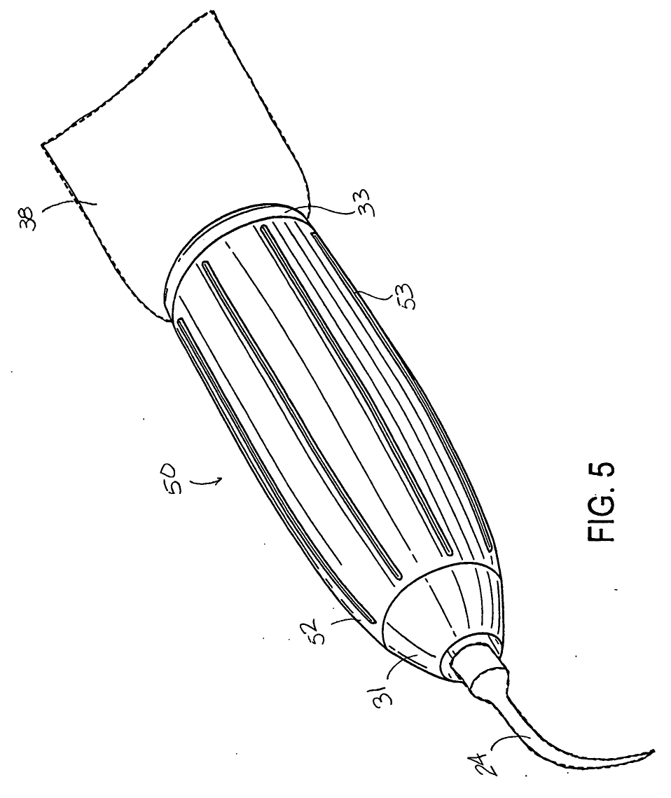

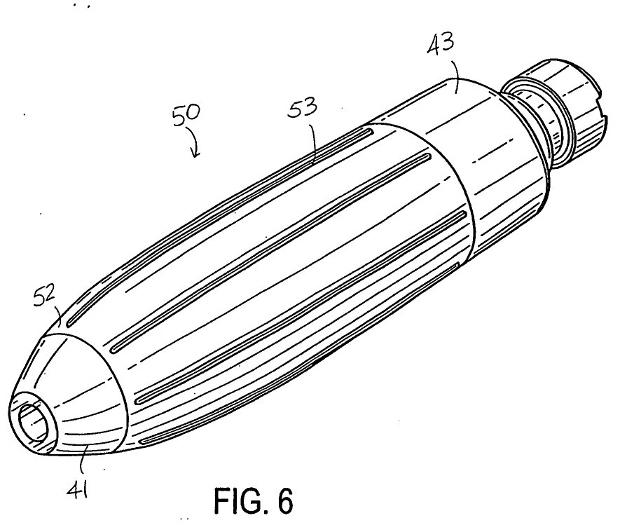

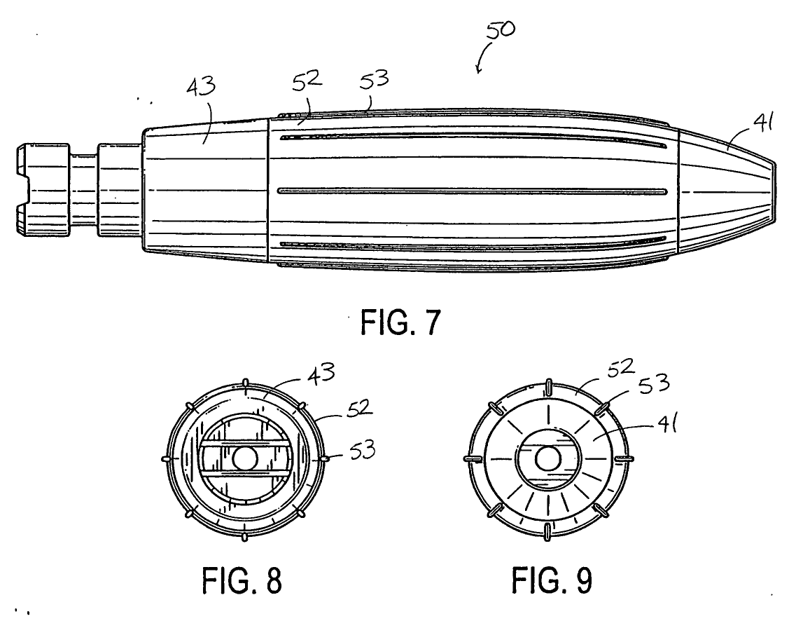

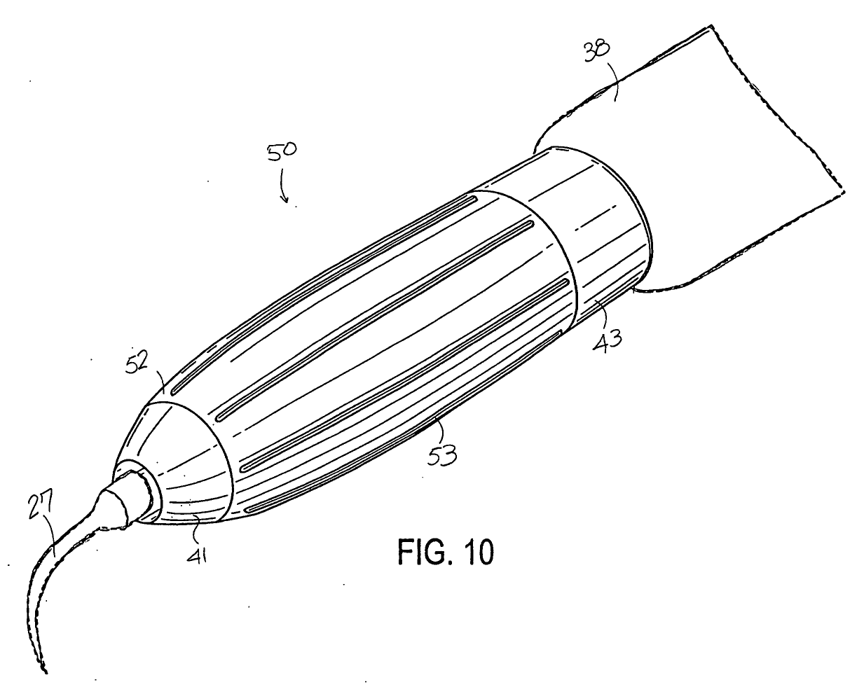

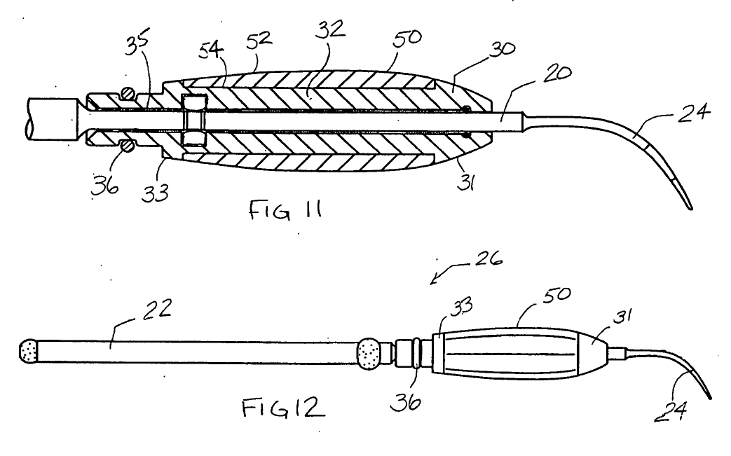

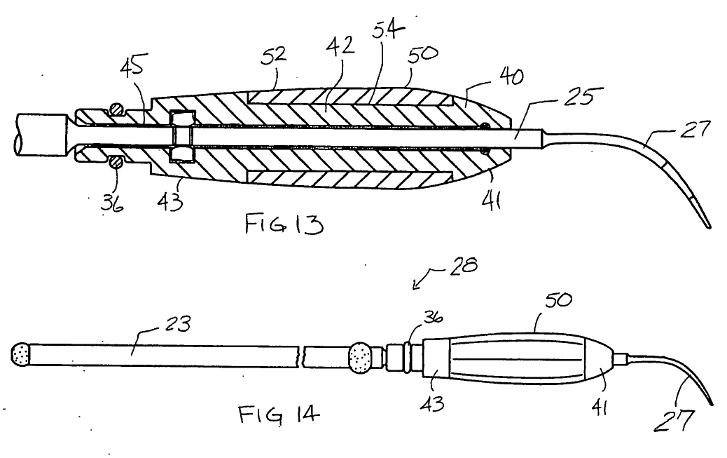

FIGS. 1-5, 11 and 12 illustrate a head portion for an ultrasonic scaler having a 30 KHz shank 20, while FIGS. 6-10, 13 and 14 illustrate a head portion for an ultrasonic scaler having a 25 KHz shank 25. Each scaler embodiment comprises a transducer stack 22, 23 that causes the scaler insert 26,28 and thus the scaler tip 24, 27 to vibrate at their respective ultrasonic frequencies. Transducer stack 22, 23 may be coupled to grip 50 of scaler insert 26, 28 via cavity 35, 45, into which transducer 22, 23 is inserted to form, for example, a friction fit.

In FIGS. 1-5, 11 and 12, the scaler body 30 is preferably formed as a hard, plastic material having a front portion 31, a rear portion 33 and a central portion 32 disposed therebetween. The central portion 32 is adhered to the shank 20 by a suitable adhesive 35, while the scaler body 30 is fitted to the handle 38 by an 0-ring 36. Similarly, in FIGS. 6-10, 13 and 14, the scaler body 40 is preferably formed as a hard, plastic material having a front portion 41, a rear portion 43 and a central portion 42 disposed therebetween. The central portion 42 is adhered to the shank 25 by a suitable adhesive 45, while the scaler body 40 is fitted to the handle 38 by an 0-ring 36.

The scaler body 30 (25 KHz embodiment), and in particular the rear portion 33, is larger than the scaler body 40 (30 KHz embodiment), which has a shorter rear portion 43. This difference in scaler body dimensions 30,40 is attributable to the difference in lengths of the respective transducer portions 22,23. Irrespective of the differences in scaler body dimensions between the illustrated embodiments, which translate into grip portions 50 of similar varying dimensions, each grip portion 50 is characterized by the same utilitarian features, and thus will be represented in each embodiment by same reference numerals.

The grip portion 50 of the invention comprises an outer gripping surface 52 and an inner attachment surface 54. Elongated ridges 53, for example, are disposed along the outer gripping surface 52 in a spaced apart relationship, preferably in uniform angular increments (see FIGS. 3, 4, 8 and 9). Such ridges 53 aid in gripping, rotation and orientation of the scaler instrument during use. A variety of alternative surface features may also be employed for this purpose (for example, equi-spaced raised dots).

The grip portion 50 is preferably made of a soft, cushioned material, such as a silicone rubber or the like, which is easy to sterilize and comfortable to handle. Other suitable grip portion materials may include, for example, natural rubber, neoprene, vinyl and foam. The gripping surface 52 is also preferably of a low durometer hardness (preferably, but not limited to, between 5-40) to lessen fatigue and to dampen the transmission of vibrations to the fingers of the user.

The grip portion 50 is attached to the scaler body along the attachment surface 54 either by a suitable adhesive or by a conventional overmolding operation. The bonding of the grip portion to the scaler body 30 prevents entry of debris or contaminants to the interior of the scaler body 30 underneath the grip portion 50, which could be hard to clean and/or sterilize. The grip portion 50 is preferably positioned between the front portion 31,41 and rear portion 33,43 of the scaler body 30,40, and may have a tubular shape so that it is easy to grasp and handle, or may have another shape that promotes gripping by a user (for example, gripping surface 52 of grip portion 50 may be produced with a triangular cross-section).

The configuration of the grip portion 50, in conjunction with the gripping surface 52 enhanced by the elongated ridges 53, enables a user to manipulate the scaler with ease and comfort. The elongated nature of the ridges 53, normally following the finger placement of a user on the grip portion, also improves the gripability and maneuverability, particularly when the grip portion is exposed to a wet or slippery environment. Furthermore, while the cushion provided by the grip portion 50 clearly reduces the transmission of vibrations to the user, and thus makes the grip more comfortable, it also enables a user to hold the scaler insert 26, 28 firmly without excessive squeezing, which further stabilizes the user's grip and the ability to manipulate and orient the scaler.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention.

What is claimed is:

1. A manual grip for a vibrating tool, the grip comprising:
a rigid body having front, rear and central portions, and a cavity positioned along a central axis of the rigid body;
a soft grip portion fixedly and coaxially attached to the central portion, the grip portion being confinedly positioned on the central portion between ledges defined by the front and rear portions.

2. The manual surface grip of claim 1, wherein the soft grip portion further comprises one or more raised features on an outer surface of the grip portion, for assisting a user in at least one of gripping, rotating and orienting the manual grip.

3. The manual grip of claim 2, wherein the at least one raised feature is an elongated ridge aligned along a central axis of the grip portion.

4. The manual grip of claim 3, wherein the soft grip portion comprises a plurality of elongated ridges in a spaced-apart configuration on the outer surface of the grip portion.

5. The manual grip of claim 4, wherein the plurality of elongated ridges are spaced apart in uniform angular increments with respect to the central axis of the grip portion.

6. The manual grip of claim 1, wherein the rear portion comprises a narrowed cylindrical segment for fitting the manual grip to a handle.

7. The manual grip of claim 6, wherein the narrowed cylindrical segment further comprises an annular groove for retaining an O-ring for sealably fitting the manual grip to the handle.

8. The manual grip of claim 1, wherein the rigid body comprises a hard plastic.

9. The manual grip of claim 1, wherein the soft grip portion includes at least one of silicone rubber, natural rubber, neoprene, vinyl and foam.

10. The manual grip of claim 1, wherein the soft grip portion includes a material having a durometer hardness of between 5 and 40.

11. The manual grip of claim 1, wherein the soft grip portion has a tubular cross-sectional shape.

12. The manual grip of claim 1, wherein the soft grip portion has a triangular cross-sectional shape.

13. The manual grip of claim 1, wherein the soft grip portion is fixedly attached to the central portion with an adhesive.

14. The manual grip of claim 1, wherein the soft grip portion is fixedly attached to the central portion by overmolding the soft grip portion onto the rigid body.

15. A head portion for an ultrasonic scaler, comprising:
a shank terminating at an operative end in a scaler tip;
a transducer stack for causing vibration of the scaler tip;
a rigid body having front, rear and central portions, a first cavity positioned along a central axis of the rigid body for fixedly receiving the shank, and a second cavity positioned along the central axis of the rigid body for fixedly receiving the transducer stack; and
a soft grip portion fixedly and coaxially attached to the central portion, the grip portion being confinedly positioned on the central portion between ledges defined by the front and rear portions.

16. The scaler head portion of claim 15, wherein the rear portion of the rigid body further comprises a narrowed cylindrical segment having an annular groove that seats an O-ring, said cylindrical segment and O-ring for sealably fitting the scaler head portion to a scaler handle.

17. The scaler head portion of claim 15, wherein the shank is affixed to the rigid body by an adhesive.

18. The scaler head portion of claim 15, wherein the transducer stack is affixed to the rigid body by an adhesive.

19. The scaler head portion of claim 15, wherein the rigid body further comprises a third cavity interposed along the central axis between the first and second cavities, the third cavity thereby isolating the first cavity from the second cavity.
